(19) United States
(12) Patent Application Publication
(10) Pub. No.: US 2012/0197709 A1
(43) Pub. Date: Aug. 2, 2012

(54) Mobile Advertisement with Social Component for Geo-Social Networking System

(76) Inventors: Timothy Kendall, San Francisco, CA (US); Evan Howell Sharp, San Francisco, CA (US); Bo Hu, San Jose, CA (US); Daniel Jeng-Ping Hui, Palo Alto, CA (US); Thomas Giovanni Carriero, San Francisco, CA (US)

(21) Appl. No.: 13/019,061

(22) Filed: Feb. 1, 2011

(51) Int. Cl. G06Q 30/00

(52) U.S. Cl. 705/14.36

(57) ABSTRACT

In one embodiment, a geo-social networking system receives from a first user's location a message identifying the first user and one or more other users, generating a redeemable certificate including pictures of the first user and the one or more other users, and present the redeemable certificate to the first user.

### TECHNICAL FIELD

The present disclosure relates generally to a geo-social networking service and, more particularly to, a system for mobile advertisement with social component.

### BACKGROUND

A social networking system, such as a social networking website, enables its users to interact with it and with each other through the system. The social networking system may create and store a record, often referred to as a user profile, in connection with the user. The user profile may include a user's demographic information, communication channel information, and personal interest. The social networking system may also create and store a record of a user's relationship with other users in the social networking system (e.g., social graph), as well as provide services (e.g., wall-posts, photo-sharing, or instant messaging) to facilitate social interaction between users in the social networking system. A geo-social networking system is a social networking system in which geographic services and capabilities are used to enable additional social interactions. User-submitted location data or geo-location techniques (e.g., mobile phone position tracking) can allow a geo-social network to connect and coordinate users with local people or events that match their interests. For example, users can check-in to a place using a mobile client application by providing a name of a place (or selecting a place from a pre-established list of places). The geo-social networking system, among other things, can record information about the user's presence at the place and possibly provide this information to other users of the geo-social networking system.

### SUMMARY

Particular embodiments relate to receiving from a first user's location a message identifying the first user and one or more other users, generating a redeemable certificate including pictures of the first user and the one or more other users, and presenting the redeemable certificate to the first user. These and other features, aspects, and advantages of the disclosure are described in more detail below in the detailed description and in conjunction with the following figures.

### BRIEF DESCRIPTION OF THE DRAWINGS

FIG. 1 illustrates an example social networking system.

FIG. 2 illustrates an example method of dynamically ranking places based on proximity and existence of advertisements.

FIGS. 3 and 3A illustrates examples of presenting a ranked list of places.

FIGS. 4 and 4A illustrate examples of generating and presenting an coupon to a user based on the user's social action.

FIG. 5 illustrates an example network environment.

FIG. 6 illustrates an example computer system.

FIG. 7 illustrates an example mobile device platform.

### DETAILED DESCRIPTION

The invention is now described in detail with reference to a few embodiments thereof as illustrated in the accompanying drawings. In the following description, numerous specific details are set forth in order to provide a thorough understanding of the present disclosure. It is apparent, however, to one skilled in the art, that the present disclosure may be practiced without some or all of these specific details. In other instances, well known process steps and/or structures have not been described in detail in order not to unnecessarily obscure the present disclosure. In addition, while the disclosure is described in conjunction with the particular embodiments, it should be understood that this description is not intended to limit the disclosure to the described embodiments. To the contrary, the description is intended to cover alternatives, modifications, and equivalents as may be included within the spirit and scope of the disclosure as defined by the appended claims.

A social networking system, such as a social networking website, enables its users to interact with it, and with each other through, the system. Typically, to become a registered user of a social networking system, an entity, either human or non-human, registers for an account with the social networking system. Thereafter, the registered user may log into the social networking system via an account by providing, for example, a correct login ID or username and password. As used herein, a “user” may be an individual (human user), an entity (e.g., an enterprise, business, or third party application), or a group (e.g., of individuals or entities) that interacts or communicates with or over such a social network environment.

When a user registers for an account with a social networking system, the social networking system may create and store a record, often referred to as a “user profile”, in connection with the user. The user profile may include information provided by the user and information gathered by various systems, including the social networking system, relating to activities or actions of the user. For example, the user may provide his name, profile picture, contact information, birth date, gender, marital status, family status, employment, education background, preferences, interests, and other demographical information to be included in his user profile. The user may identify other users of the social networking system that the user considers to be his friends. A list of the user's friends or first degree contacts may be included in the user's profile. Connections in social networking systems may be in both directions or may be in just one direction. For example, if Bob and Joe are both users and connect with each another, Bob and Joe are each connections of the other. If, on the other hand, Bob wishes to connect to Sam to view Sam's posted content items, but Sam does not choose to connect to Bob, a one-way connection may be formed where Sam is Bob's connection, but Bob is not Sam's connection. Some embodiments of a social networking system allow the connection to be indirect via one or more levels of connections (e.g., friends of friends). Connections may be added explicitly by a user, for example, the user selecting a particular other user to be a friend, or automatically created by the social networking system based on common characteristics of the users (e.g., users who are alumni of the same educational institution). The user may identify or bookmark websites or web pages he visits frequently and these websites or web pages may be included in the user's profile.

The user may provide information relating to various aspects of the user (such as contact information and interests) at the time the user registers for an account or at a later time. The user may also update his or her profile information at any time. For example, when the user moves, or changes a phone number, he may update his contact information. Additionally, the user's interests may change as time passes, and the user may update his interests in his profile from time to time. A user's activities on the social networking system, such as frequency of accessing particular information on the system, may also provide information that may be included in the user's profile. Again, such information may be updated from time to time to reflect the user's most-recent activities. Still further, other users or so-called friends or contacts of the user may also perform activities that affect or cause updates to a user's profile. For example, a contact may add the user as a friend (or remove the user as a friend). A contact may also write messages to the user's profile pages--typically known as wall-posts. A user may also input status messages that get posted to the user's profile page.

A social network system may maintain social graph information, which can generally model the relationships among groups of individuals, and may include relationships ranging from casual acquaintances to close familial bonds. A social network may be represented using a graph structure. Each node of the graph corresponds to a member of the social network. Edges connecting two nodes represent a relationship between two users. In addition, the degree of separation between any two nodes is defined as the minimum number of hops required to traverse the graph from one node to the other. A degree of separation between two users can be considered a measure of relatedness between the two users represented by the nodes in the graph.

A social networking system may support a variety of applications, such as photo sharing, on-line calendars and events. For example, the social networking system may also include media sharing capabilities. For example, the social networking system may allow users to post photographs and other multimedia files to a user's profile, such as in a wall post or in a photo album, both of which may be accessible to other users of the social networking system. Social networking system may also allow users to configure events. For example, a first user may configure an event with attributes including time and date of the event, location of the event and other users invited to the event. The invited users may receive invitations to the event and respond (such as by accepting the invitation or declining it). Furthermore, social networking system may allow users to maintain a personal calendar. Similarly to events, the calendar entries may include times, dates, locations and identities of other users.

The social networking system may also support a privacy model. A user may or may not wish to share his information with other users or third-party applications, or a user may wish to share his information only with specific users or third-party applications. A user may control whether his information is shared with other users or third-party applications through privacy settings associated with his user profile. For example, a user may select a privacy setting for each user datum associated with the user and/or select settings that apply globally or to categories or types of user profile information. A privacy setting defines, or identifies, the set of entities (e.g., other users, connections of the user, friends of friends, or third party application) that may have access to the user datum. The privacy setting may be specified on various levels of granularity, such as by specifying particular entities in the social network (e.g., other users), predefined groups of the user's connections, a particular type of connections, all of the user's connections, all first-degree connections of the user's connections, the entire social network, or even the entire Internet (e.g., to make the posted content item index-able and searchable on the Internet). A user may choose a default privacy setting for all user data that is to be posted. Additionally, a user may specifically exclude certain entities from viewing a user datum or a particular type of user data.

Social networking system may maintain a database of information relating to geographic locations or places. Places may correspond to various physical locations, such as restaurants, bars, train stations, airports and the like. Some places may correspond to larger regions that themselves contain places—such as a restaurant or a gate location in an airport. In one implementation, each place can be maintained as a hub node in a social graph or other data structure maintained by the social networking system, as described in U.S. patent application Ser. No. 12/763,171, which is incorporated by reference herein for all purposes. Social networking system may allow users to access information regarding each place using a client application (e.g., a browser) hosted by a wired or wireless station, such as a laptop, desktop or mobile device. For example, social networking system may serve web pages (or other structured documents) to users that request information about a place.

In addition to user profile and place information, the social networking system may track or maintain other information about the user. For example, the social networking system may support geo-social networking system functionality including one or more location-based services that record the user's location. For example, users may access the geo-social networking system using a special-purpose client application hosted by a mobile device of the user (or a web- or network-based application using a browser client). The client application may automatically access Global Positioning System (GPS) or other geo-location functions supported by the mobile device and report the user's current location to the geo-social networking system. In addition, the client application may support geo-social networking functionality that allows users to check-in at various locations and communicate this location to other users. A check-in to a given place may occur when a user is physically located at a place and, using a mobile device, access the geo-social networking system to register the user's presence at the place. A user may select a place from a list of existing places near to the user's current location or create a new place. The user may also provide comments in a text string when checking in to a given place. The user may also identify one or more other users in connection with a check-in (such as friends of a user) and associate them with the check-in as well. U.S. patent application Ser. No. 12/574,614, which is incorporated by reference herein for all purposes, describes a system that allows a first user to check-in other users at a given place. An entry including a comment and a time stamp corresponding to the time the user checked in may be displayed to other users. For example, a record of the user's check-in activity may be stored in a database. Social networking system may select one or more records associated with check-in activities of users at a given place and include such check-in activity in web pages (or other structured documents) that correspond to a given place. For example, social networking system may select the check-in activity associated with the friends or other social contacts of a user that requests a page corresponding to a place. U.S. application Ser. No. 12/858,718, incorporated by reference in its entirety for all purposes, describes an example geo-social networking system that can be used in connection with various embodiments of the present invention. The check-in activity may also be displayed on a user profile page and in news feeds provided to users of the social networking system.

A social networking system may maintain a database of advertisement content from advertisers, and generate and communicate advertisements to users of the social networking system. The social networking system may increase effectiveness of advertising by provide an advertisement that are targeted to a user who is likely to be interested in the advertisement. U.S. application No. 12/195,321, incorporated by reference in its entirety for all purposes, describes a system that selects advertisements by matching targeting criteria of advertisements and a user's user profile information and past actions, and presents the selected advertisements to the user. The social networking system may also generate and communicate advertisements to a user based on the user's social graph information. For example, in addition to presenting an advertisement that is targeted to a particular user, the social networking system may communicate information about the advertisement to other users connected to the particular user. U.S. application No. 12/193,702 describes a system that selects advertisements for a targeted user by matching targeting criteria of advertisements and past actions of another user connected to the targeted user, and presented information about the matched action and the selected advertisements to the targeted user.

As discussed above, each place maintained by the geo-social networking system may exist as a hub node and be provided as a page served to users of the social networking system. The page may identify the name of the place, the geographic location of the place, graphical maps, check-in activity, user comments and the like. Many of the places may correspond to commercial establishments, such as restaurants, bars, coffee shops, retail outlets and the like. In one implementation, various persons (such as an owner of a restaurant) may seek to establish administrative privileges for the page that corresponds to a given place (such as the restaurant a particular person owns). With administrative privileges, a person may be able add, delete and/or moderate content that appears on the page. In addition, as discussed below, the place administrator may be able to register one or more advertisements in connection with the place. These advertisements may be presented to users during a check-in work flow.

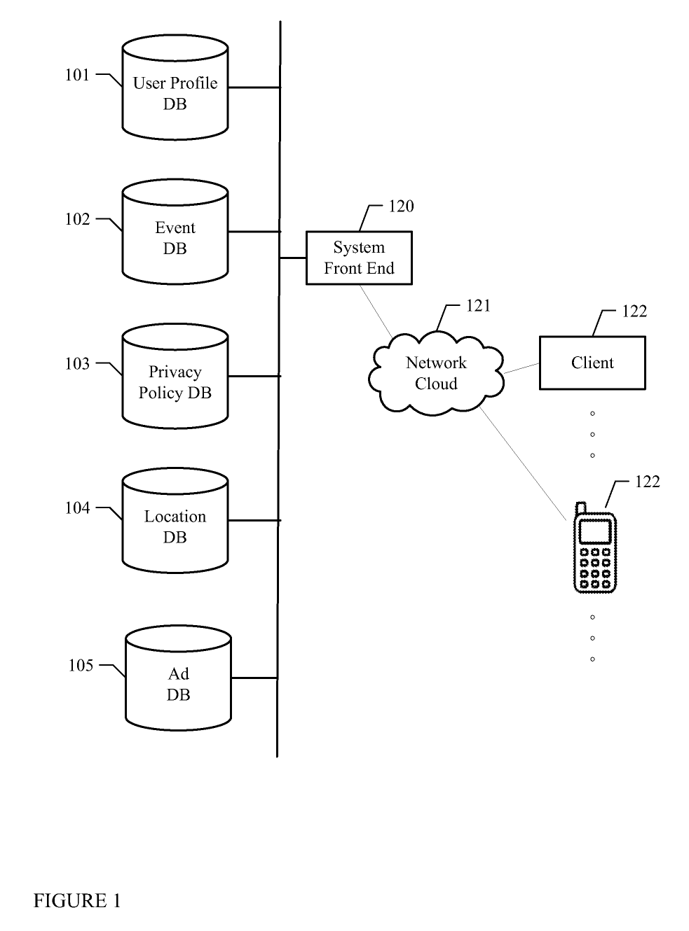

FIG. 1 illustrates an example social networking system. In particular embodiments, the social networking system may store user profile data and social graph information in user profile database 101. In particular embodiments, the social networking system may store user event data in event database 102. For example, a user may register a new event by accessing a client application to define an event name, a time and a location, and cause the newly created event to be stored in event database 102. In particular embodiments, the social networking system may store user privacy policy data in privacy policy database 103. In particular embodiments, the social networking system may store geographic and location data in location database 104. In particular embodiments, the social networking system may store advertisement data in advertisement database 105. For example, an advertiser may store advertisement content (e.g., messages, graphic arts, video clips) and related information (e.g., locations, targeting criteria) in advertisement database 105. In particular embodiments, databases 101, 102, 103, 104, and 105 may be operably connected to the social networking system's front end. In particular embodiments, the front end 120 may interact with client device 122 through network cloud 121. Client device 122 is generally a computer or computing device including functionality for communicating (e.g., remotely) over a computer network. Client device 122 may be a desktop computer, laptop computer, personal digital assistant (PDA), in- or out-of-car navigation system, smart phone or other cellular or mobile phone, or mobile gaming device, among other suitable computing devices. Client device 122 may execute one or more client applications, such as a web browser (e.g., Microsoft Windows Internet Explorer, Mozilla Firefox, Apple Safari, Google Chrome, and Opera, etc.) or special-purpose client application (e.g., Facebook for iPhone, etc.), to access and view content over a computer network. Front end 120 may include web or HTTP server functionality, as well as other functionality, to allow users to access the social networking system. Network cloud 121 generally represents a network or collection of networks (such as the Internet or a corporate intranet, or a combination of both) over which client devices 122 may access the social network system.

In particular embodiments, location database 104 may store an information base of places, where each place includes a name, a geographic location and meta information (such as the user that initially created the place, reviews, comments, check-in activity data, and the like). Places may be created by administrators of the system and/or created by users of the system. For example, a user may register a new place by accessing a client application to define a place name or a place identifier, and provide a geographic location and cause the newly created place to be registered in location database 104. Additionally, a creating user of a place can assign other users as administrators of the place. In particular embodiments, location database 104 may store geo-location data identifying a real-world geographic location of a user associated with a check-in. For example, a geographic location of an Internet connected computer can be identified by the computer's IP address. For example, a geographic location of a cell phone equipped with cellular, Wi-Fi and/or GPS capabilities can be identified by cell tower triangulation, Wi-Fi positioning, and/or GPS positioning. In particular embodiments, location database 104 may store a geographic location and additional information of a plurality of places. For example, a place can be a local business, a point of interest (e.g., Union Square in San Francisco, Calif.), a college, a city, or a national park. For example, a geographic location of a place (e.g., a local coffee shop) can be an address, a set of geographic coordinates (latitude and longitude), or a reference to another place (e.g., “the coffee shop next to the train station”). For example, a geographic location of a place with a large area (e.g., Yosemite National Park) can be a shape (e.g., a circle, or a polygon) approximating the boundary of the place and/or a centroid of the shape. For example, additional information of a place can be business hours, photos, or user reviews of the place. In particular embodiments, location database 104 may store a user's location data. For example, a user can create a place (e.g., a new restaurant or coffee shop) and the social networking system can store the created place in location database 104. For example, location database 104 may store a user's check-in activities. For example, location database 104 may store a user's geographic location provided by the user's GPS-equipped mobile device.

In particular embodiments, an administrator of a place (e.g., a coffee shop) may create one or more advertisements for the place, and store the one or more advertisements in advertisement database 105. In particular embodiments, an advertisement for a place may comprise a place identifier or a place name (e.g., “B Street Café”), advertising content and media data, redeemable certificates or coupons, and/or associated information. For example, advertising messages can be text strings (e.g., “Grand Opening!”) and media data can be graphic arts, photos or video clips. For example, coupons can be text strings for promotional messages (e.g., “50 percent off on your next latte”, “buy one espresso drink and get the second one at half price”) and related media data. For example, information associated with an advertisement can include information about advertisers (e.g., business hours, URL), business category (e.g., sporting goods, restaurant, retail clothing), one or more locations and/or places, and targeting criteria (e.g., a certain age group, a certain interest). For example, a user of the social networking system can request a structured document (e.g., a web page) of a place by sending an URL or a place name to system front end 120, by using a web browser or a special-purpose client application hosted by the user's mobile phone. System front end 120 can access location database 104 and advertisement database 105 to construct the web page including information (e.g., location, business hours) about the place, and an advertisement and a coupon promoted by the place, and cause the web browser (or the special-purpose client application) to display the web page.

In addition to presenting an advertisement embedded in a structured documented requested by a user, the social networking system may present an advertisement to a user based on the user's location and social actions (e.g., a place check-in, or an online review about a restaurant). Particular embodiments herein describe methods of presenting advertisements to a user based on the user's location data and social actions. Particular embodiments herein can be implemented by a mobile advertising process hosted by one or more computing devices of the geo-social networking system and a user's mobile device, such as a mobile phone or a laptop. In one implementation, ads may be presented to users during a check-in work flow.

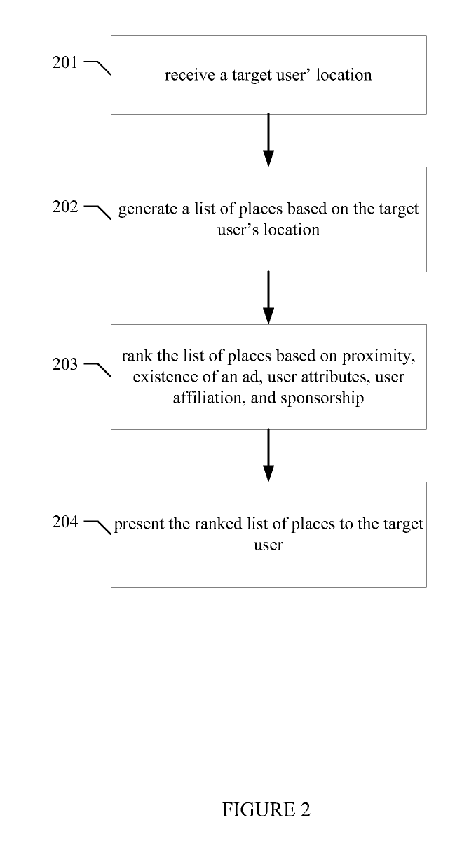

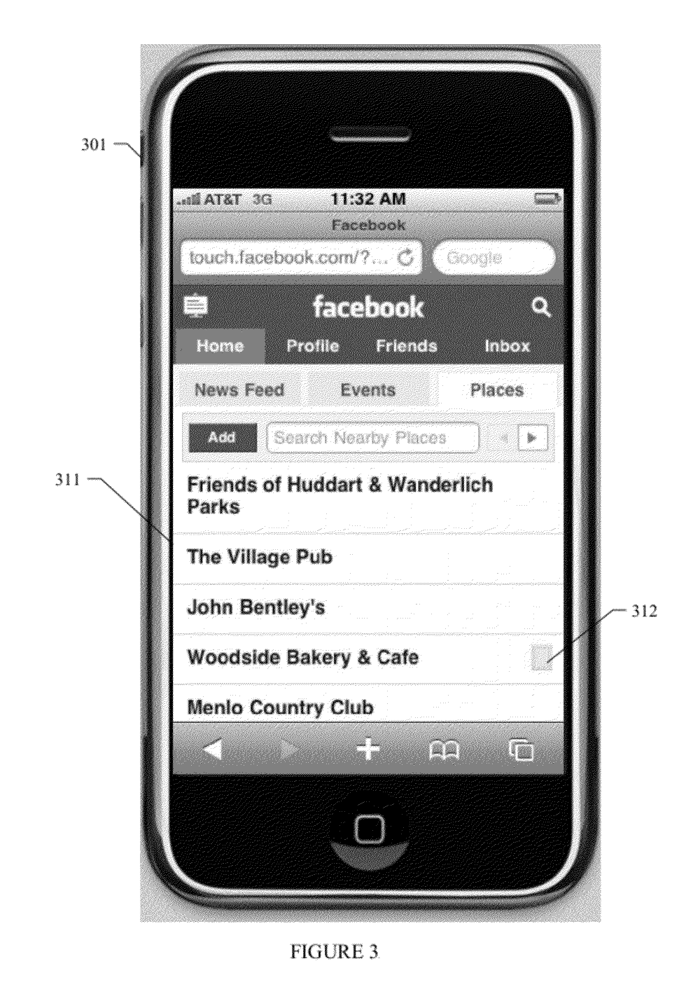

FIG. 2 illustrates an example method of dynamically ranking places based on proximity and existence of advertisements. In one implementation, the mobile advertising processes and functionality described herein can be integrated into a geo-social networking system. In particular embodiments, the mobile advertising process may receive data indicating a location of a target user (201). For example, the mobile advertising process can receive a message that identifies the geographic location of the target user. In particular embodiments, the request message may include a user id of the user and a geographic location of the user. For example, the mobile advertising process can receive a geographic location from the target user's GPS-equipped mobile phone. In connection with a check-in or a general search of nearby places, a user can search a place near the user's current location by providing text (such as a text string that contains a full or partial name) describing a place (such as a name of the place, or a category or concept associated with a place) and/or a geographic location to the geo-social networking system. The geo-social networking system may search location database 104 and provide the user a list of places near the geographic location that match the text string (if provided). Still further, a list of places may be presented to a user after a check-in. For example, after a mobile advertising process receives an indication that the target user has checked in at a department store from a special-purpose client application hosted by the target user's mobile phone, the process may present a ranked list of nearby places to the user.

As discussed above, the request may additionally include a character string. In particular embodiments, places service 110 may access location database 104 to identify a set of one or more places wherein a place identifier (e.g., a name, a metadata value) of each place matches the character string partially or completely and where the place is within some threshold distance of the user's current location. For example, if a user wants to check in to a nearby coffee shop, the user can type “coffe” in a web page or a client application with the search request. Places service 110 can return a list of nearby coffee shops, e.g., Starbucks Coffee, Peet's Coffee and Tea, Dunkin' Donuts, etc. The client application that provides the user interface may periodically transmit the text string in a search request as the user enters additional text or changes existing text in the text entry field, possibly causing the places service 110 to transmit a renewed list of places to the client application. In other implementations, the client application may also retransmit the search request if the current location of the user changes by more than a threshold distance. The search request may also include other parameters, such as tags or categories, that can be used to filter and/or rank the results.

In particular embodiments, the mobile advertising process may access a data store of places and generate a list of places based on the target user's location (202). In particular embodiments, the mobile advertising process may generate the list of places comprising one or more places within a pre-determined distance from the target user's location as identified in a message transmitted to the geo-social networking system. For example, the mobile advertising process can access location database 104 and generate the list of places comprising one or more places within a half-mile from the target user's geographic location (e.g., 37° 46′42.13″ N, 122° 23′24.27″ W). For example, the mobile advertising process can access location database and generate the list of places comprising one or more places within 1000 feet from a first place that the target user just checked in (e.g., “AT&T Park, San Francisco, Calif.”). In particular embodiments, the mobile advertising process may, for each place of the list of places, access advertisement database 105 to determine whether one or more advertisements are associated with the place.

In particular embodiments, the mobile advertising process may rank the list of places based on respective distances between the target user's location and each place, and whether an advertisement is associated with the place (203). For example, the mobile advertising process can rank the list of places by ordering the places by distance, e.g., a place that is closest to the target user's location is ranked at the top of the list of places. For example, if a particular place of the list of places has an associated advertisement, and the rest of the list of places do not, the mobile advertising process can rank the particular place to the top of the list of places even the particular place is not the closest to the target user's location among the list of places. In other implementations, ranking of places can be based on a rank score that includes a distance component and an advertising component. In one implementation, each of the distance and advertising components can be weighted to achieve various system behaviors. In one implementation, the distance component is based on a function that varies with distance between the user's current location and the location of the corresponding place. The advertising component can be a score that is based on a function that considers a variety of factors, such as revenue attributable to the geo-social networking system for a conversion or check-in, an amount bid by the administrator of the place, and the like. Other implementations may also include a text string matching component that provides a score that varies with the degree to which a given place name matches a text string provided by a user.

Additionally, the mobile advertising process can rank the list of places based on other information. In particular embodiments, the mobile advertising process may rank the list of places based on the target user's attributes. For example, the mobile advertising process can access user profile database 101 for the target user's attributes (e.g., 20 years old, male) and rank a particular place with a matching targeting criteria (e.g., 15 to 25 years old age group) to the top of the list of places. In particular embodiments, the mobile advertising process may rank the list of places based on the target user's affiliation. For example, the mobile advertising process can access user profile database 101 and/or location database 104 for the target user's affiliations on and off the social network, e.g., categories of past check-ins (e.g., Japanese restaurant), the target user's interests as stated on or off the social network (e.g., sushi), and rank one or more places with matching category (e.g., a sushi restaurant) to the top of the list of places. In particular embodiments, the mobile advertising process may rank the list of places based on whether a sponsorship is associated with the place. For example, a sponsorship can be a paid or sponsored advertisement associated with a place. For example, a sponsorship can be a sponsorship associated with a place itself. For example, the mobile advertising process can for each place of the list of places, access location database 104 and advertisement database 105 to determine whether a sponsorship is associated with the place, and rank places with associated sponsorships to the top of the list of places.

Still further, the mobile advertising process may rank the list of places based on the check-in activities of other users. U.S. application Ser. No. 12/858,758, which is incorporated by reference herein for all purposes, discloses how places may be ranked based on the check-in activities of the user and other users of the social networking system. The component scores described herein can be incorporated into the ranking methodology disclosed in U.S. application Ser. No. 12/858,758 to provide a ranked set of places to a user. In one implementation, the ranking score may be an aggregation of component scores, where a first component score is based on distance and the six remaining component scores are based, in part, on the values in the social activity table disclosed in U.S. application Ser. No. 12/858,758 and other component scores are based on the attributes discussed above, such as advertisements and the like. In one implementation, the ranking score may be computed according to the following equation:

Ranking Score=Distance−Weighted Sum of Component Scores (CS1 to CSN). In addition, the component scores may be individually weighted. In one implementation, the component scores are weighted relative to the distance component score to reflect how much social and advertising context (as reflected in a component score) is worth relative to distance.

In particular embodiments, the mobile advertising process may present the ranked list of places to the target user (204). FIGS. 3 and 3A illustrate example user interfaces presenting a ranked list of places. In the examples of FIGS. 3 and 3A, the mobile advertising process receives a geographic location of a user from a special-purpose client application hosted by the user's GPS-equipped mobile phone 301, determines a ranked list of places based distance to the user's location as described in the example method of FIG. 2, and presents the ranked list of place to the user in a user interface of the special-purpose client application (311). For example, the mobile advertising process may present a marker 312 indicating an advertisement is associated with a particular place. For example, the mobile advertising process can rank the particular place with an advertisement to the top of the ranked list of places, as illustrated in FIG. 3A. In one implementation, the marker 312 is selectable by the user and causes an advertisement or offer to be presented to a user. In this manner by ranking places based on advertisements, compelling and relevant offers associated with places near the users current location may be more readily surfaced to the user.

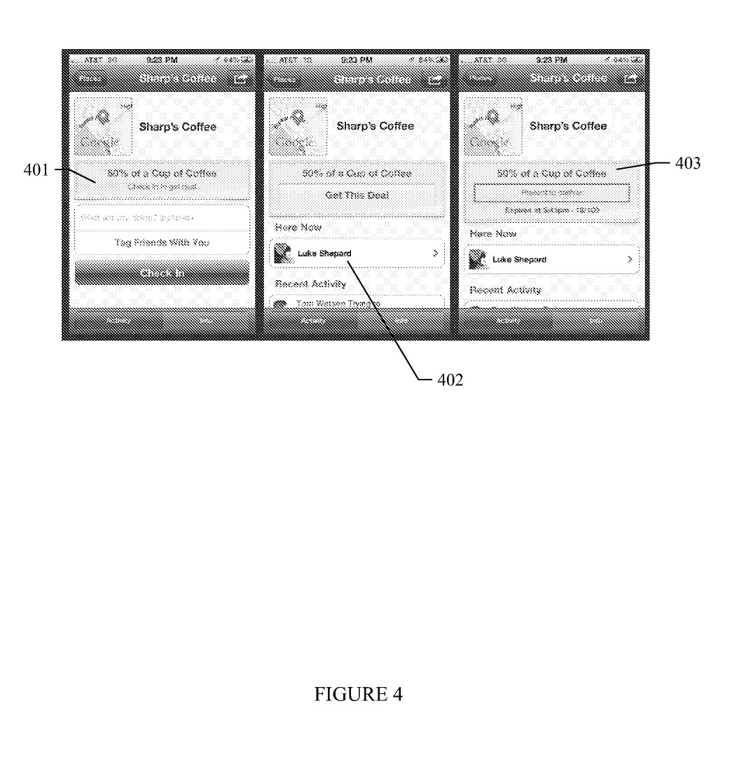

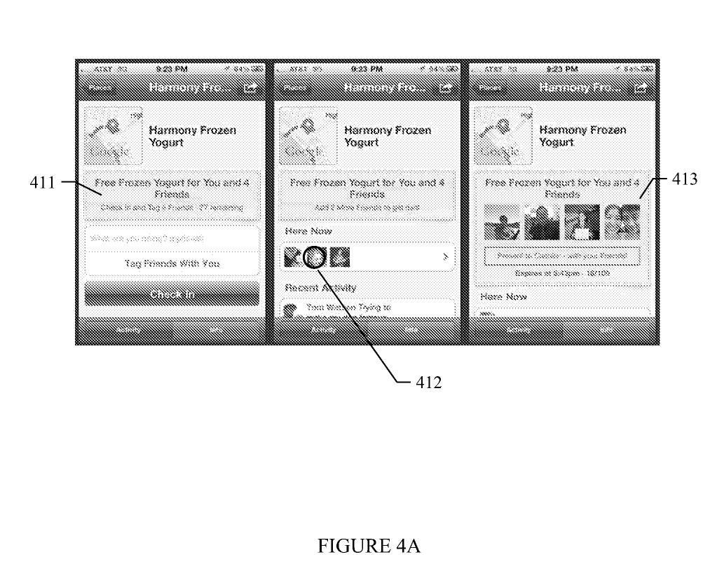

Additionally, the mobile advertising process can generate and present a redeemable certificate or coupon to a user. In one implementation, the coupon or certificate offer may include a social action requirement. FIG. 4 illustrates an example user interface sequence associated with generating and presenting a coupon to a user that includes a social action requirement. In particular embodiments, the mobile advertising process may generate and present an advertisement to a user based on the user's location. As illustrated in FIG. 4, the mobile advertising process can receive a geographic location from a special-purpose client application hosted by the user's GPS-equipped mobile phone (e.g. Facebook for iPhone), determine a place near the user's location (e.g., “Sharp's Coffee”), generate and present an advertisement associated with the place to the user in a graphic user interface of the special-purpose client application (401) indicating the place and an available coupon (“50% of a Cup of Coffee”), and entice a social action from the user to retrieve the advertisement (“Check in to get deal”). In particular embodiments, the mobile advertising process may receive a check-in message from the user. In particular embodiments, the mobile advertising process may generate and present the coupon to the user that offers the user an incentive to check in to the place.

In the example of FIG. 4, the mobile advertising process can receive an indication that the user has selected a given place via the special-purpose client application. For example, when presented with a list of places as shown in FIG. 3, a user may select a place, causing the client application to transmit the selection to the geo-social networking system. The geo-social networking system may transmit a response comprising a structured document that includes information about the selected place. The structured document 401, as shown in FIG. 4, may identify the place, include an offer and further comprise controls for checking in to the place. In the user interface 401, the offer indicates that the user may receive 50 percent towards the purchase of a coffee if the user checks-in to the place. User interface 402 may be presented to the user after completing a check-in process. In the user interface 402, the user may redeem the coupon by clicking on the “get this deal” control, causing an electronic coupon interface 403 to appear. The check-in activity of the user and the coupon that the user received may be presented as news feed items accessible to the user and other users of the social networking system. As FIG. 4 illustrates, the user may present the electronic coupon to a person associated with the place for redemption. In some embodiments, the coupon may comprise a machine-readable, graphical symbol or other representation of data (e.g., a barcode, a QR code) for additional validation and record keeping of the coupon for merchants. In one implementation, the electronic coupon is a structured document transmitted by the social networking system to the client application hosted by the mobile device of the user. The client application processes the structured document and displays the information illustrated in the Figures described herein on a user interface display.

FIG. 4A illustrates another example user interface sequence associated with generating and presenting a coupon to a user based on the fulfilling a social requirement. In particular embodiments, the mobile advertising process may generate and present an advertisement to a target user when the user selects a location, for example, from a list of places. As illustrated in FIG. 4A, the mobile advertising process may generate a first user interface 411 that includes a coupon offer with a social component requiring the user to check-in and tag at least N (e.g., N=4 or other number configured by an administrator) number of friends or contacts of the user in connection with the check-in. As FIG. 4A illustrates, the interface 411 includes controls allowing the user to tag friends that are with the user at the place in connection with a check-in. After the user has checked in, the geo-social networking system may present the user with interface 412 if the user has not yet tagged a required number of friends. After the user has checked in the required number of friends, geo-social networking system may present user interface 413 that includes an electronic coupon for redemption. In some implementations, the geo-social networking system may transmit confirmation requests to the tagged users asking them to confirm that they are present at the place. As discussed above, the coupon offer (“Free Frozen Yogurt for you and 4 Friends”) may entice a social action from the target user to obtain the coupon (“Check in and Tag 4 Friends”).

In particular embodiments, when constructing the electronic coupon for redemption, the mobile advertising process may access a data store for pictures or other user information corresponding to the target user and the one or more other users. In particular embodiments, the mobile advertising process may generate a coupon including the pictures corresponding to the target user and the one or more other users, and present the coupon to the target user. For example in FIG. 4A, after receiving the message indicating that the required social action has been completed, the mobile advertising can access user profile database 101 for profile pictures of the target user and the tagged users, generate the coupon including the profile pictures of the target user and the four other users, and present the coupon to the target user in the graphic user interface of the special-purpose client application (413). The target user may then present the electronic coupon to a cashier at the place, who may then use the profile pictures to validate that the tagged users are also at the location. In one implementation, the pictures in the electronic coupon are activatable interface elements that link to the user profiles of the corresponding tagged users. In another implementation, the generated coupon with the profile photos may be displayed on a news feed in the social network or a page on the social network that is associated with the advertiser redeeming the coupon.

In addition to a user check-in, the mobile advertising process may generate an advertisement based on other social actions. For example, the mobile advertising process can receive a message via an API (application programming interface) to a third-party website that a user recently rated or wrote a review about a restaurant (i.e., a social action) at the third-party website, the mobile advertising process can then send an email including a coupon for the restaurant to the user and the user's first-degree friends, or display an advertisement of the restaurant in the user's personal profile page. The advertisement may also include an offer inviting the user to come to the location and check-in the user (and other users) to receive a coupon or other offer. Other social condition, besides checking in and tagging X number of friends, required for activating a geo-location coupon include asking a user to check-in and upload a photo, tag or mention the advertiser in a status update, and like a page on the social network associated with the advertiser. The mobile advertising process may identify a social condition required for a user to activate a geo-location coupon by example methods described in U.S. patent application Ser. No. 12/496,606, which is incorporated by reference herein for all purposes and can be used in connection with various embodiments of the present invention.

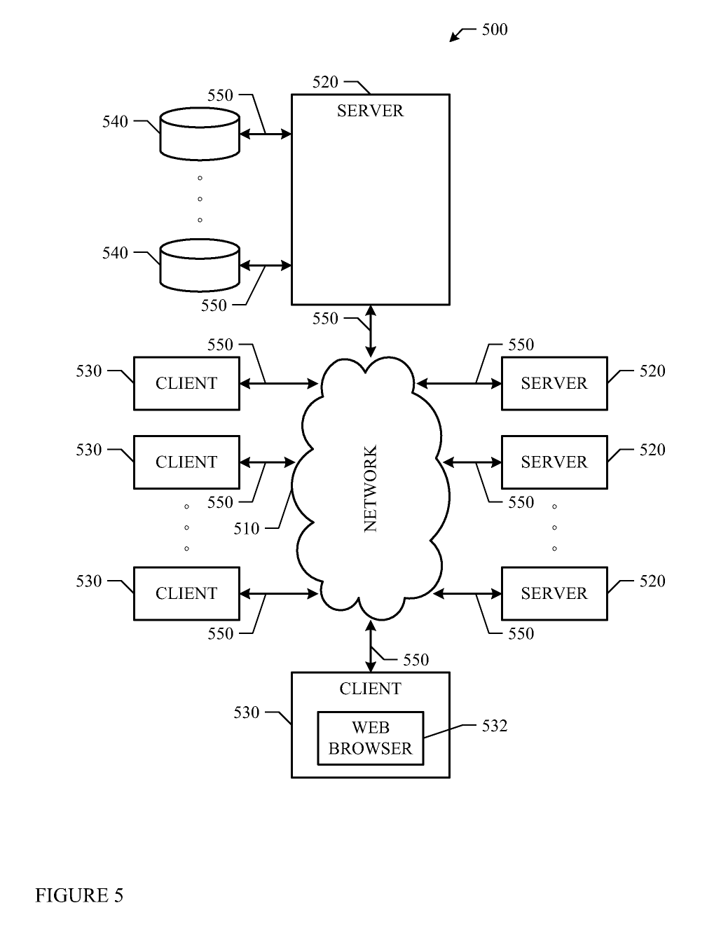

While the foregoing embodiments may be implemented in a variety of network configurations, the following illustrates an example network environment for didactic, and not limiting, purposes. FIG. 5 illustrates an example network environment 500. Network environment 500 includes a network 510 coupling one or more servers 520 and one or more clients 530 to each other. Network environment 500 also includes one or more data storage 540 linked to one or more servers 520. Particular embodiments may be implemented in network environment 500. For example, social networking system frontend 120 may be written in software programs hosted by one or more servers 520. For example, event database 102 may be stored in one or more storage 540. In particular embodiments, network 510 is an intranet, an extranet, a virtual private network (VPN), a local area network (LAN), a wireless LAN (WLAN), a wide area network (WAN), a metropolitan area network (MAN), a portion of the Internet, or another network 510 or a combination of two or more such networks 510. The present disclosure contemplates any suitable network 510.

One or more links 550 couple a server 520 or a client 530 to network 510. In particular embodiments, one or more links 550 each includes one or more wired, wireless, or optical links 550. In particular embodiments, one or more links 550 each includes an intranet, an extranet, a VPN, a LAN, a WLAN, a WAN, a MAN, a portion of the Internet, or another link 550 or a combination of two or more such links 550. The present disclosure contemplates any suitable links 550 coupling servers 520 and clients 530 to network 510.

In particular embodiments, each server 520 may be a unitary server or may be a distributed server spanning multiple computers or multiple datacenters. Servers 520 may be of various types, such as, for example and without limitation, web server, news server, mail server, message server, advertising server, file server, application server, exchange server, database server, or proxy server. In particular embodiments, each server 520 may include hardware, software, or embedded logic components or a combination of two or more such components for carrying out the appropriate functionalities implemented or supported by server 520. For example, a web server is generally capable of hosting websites containing web pages or particular elements of web pages. More specifically, a web server may host HTML files or other file types, or may dynamically create or constitute files upon a request, and communicate them to clients 530 in response to HTTP or other requests from clients 530. A mail server is generally capable of providing electronic mail services to various clients 530. A database server is generally capable of providing an interface for managing data stored in one or more data stores.

In particular embodiments, one or more data storages 540 may be communicatively linked to one or more servers 520 via one or more links 550. In particular embodiments, data storages 540 may be used to store various types of information. In particular embodiments, the information stored in data storages 540 may be organized according to specific data structures. In particular embodiment, each data storage 540 may be a relational database. Particular embodiments may provide interfaces that enable servers 520 or clients 530 to manage, e.g., retrieve, modify, add, or delete, the information stored in data storage 540.

In particular embodiments, each client 530 may be an electronic device including hardware, software, or embedded logic components or a combination of two or more such components and capable of carrying out the appropriate functions implemented or supported by client 530. For example and without limitation, a client 530 may be a desktop computer system, a notebook computer system, a netbook computer system, a handheld electronic device, or a mobile telephone. The present disclosure contemplates any suitable clients 530. A client 530 may enable a network user at client 530 to access network 530. A client 530 may enable its user to communicate with other users at other clients 530.

A client 530 may have a web browser 532, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at client 530 may enter a Uniform Resource Locator (URL) or other address directing the web browser 532 to a server 520, and the web browser 532 may generate a Hyper Text Transfer Protocol (HTTP) request and communicate the HTTP request to server 520. Server 520 may accept the HTTP request and communicate to client 530 one or more Hyper Text Markup Language (HTML) files responsive to the HTTP request. Client 530 may render a web page based on the HTML files from server 520 for presentation to the user. The present disclosure contemplates any suitable web page files. As an example and not by way of limitation, web pages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a web page encompasses one or more corresponding web page files (which a browser may use to render the web page) and vice versa, where appropriate.

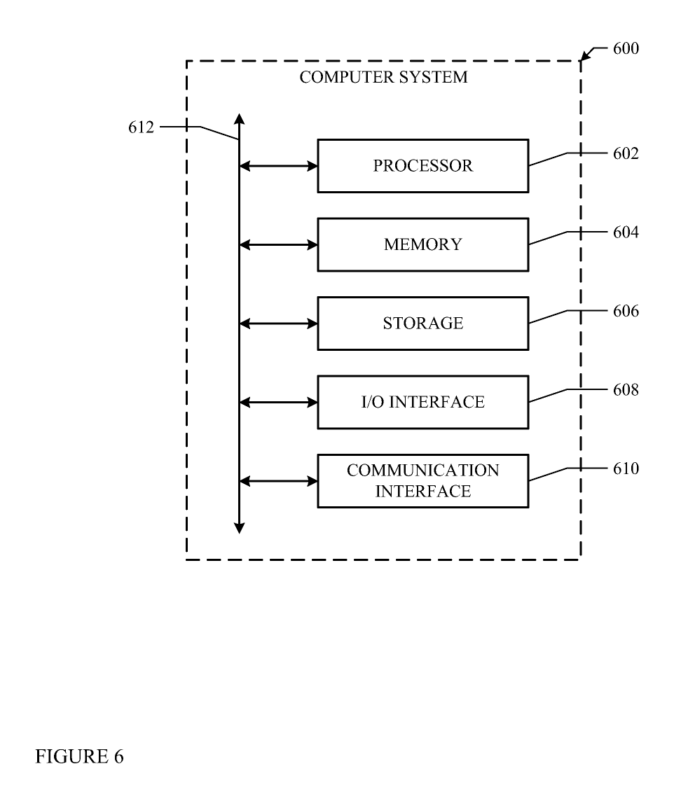

FIG. 6 illustrates an example computer system 600, which may be used with some embodiments of the present invention. This disclosure contemplates any suitable number of computer systems 600. This disclosure contemplates computer system 600 taking any suitable physical form. As example and not by way of limitation, computer system 600 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, computer system 600 may include one or more computer systems 600; be unitary or distributed; span multiple locations; span multiple machines; or reside in a cloud, which may include one or more cloud components in one or more networks. Where appropriate, one or more computer systems 600 may perform without substantial spatial or temporal limitation one or more steps of one or more methods described or illustrated herein. As an example and not by way of limitation, one or more computer systems 600 may perform in real time or in batch mode one or more steps of one or more methods described or illustrated herein. One or more computer systems 600 may perform at different times or at different locations one or more steps of one or more methods described or illustrated herein, where appropriate.

In particular embodiments, computer system 600 includes a processor 602, memory 604, storage 606, an input/output (I/O) interface 608, a communication interface 610, and a bus 612. Although this disclosure describes and illustrates a particular computer system having a particular number of particular components in a particular arrangement, this disclosure contemplates any suitable computer system having any suitable number of any suitable components in any suitable arrangement.

In particular embodiments, processor 602 includes hardware for executing instructions, such as those making up a computer program. As an example and not by way of limitation, to execute instructions, processor 602 may retrieve (or fetch) the instructions from an internal register, an internal cache, memory 604, or storage 606; decode and execute them; and then write one or more results to an internal register, an internal cache, memory 604, or storage 606. In particular embodiments, processor 602 may include one or more internal caches for data, instructions, or addresses. The present disclosure contemplates processor 602 including any suitable number of any suitable internal caches, where appropriate. As an example and not by way of limitation, processor 602 may include one or more instruction caches, one or more data caches, and one or more translation look-aside buffers (TLBs). Instructions in the instruction caches may be copies of instructions in memory 604 or storage 606, and the instruction caches may speed up retrieval of those instructions by processor 602. Data in the data caches may be copies of data in memory 604 or storage 606 for instructions executing at processor 602 to operate on; the results of previous instructions executed at processor 602 for access by subsequent instructions executing at processor 602 or for writing to memory 604 or storage 606; or other suitable data. The data caches may speed up read or write operations by processor 602. The TLBs may speed up virtual-address translation for processor 602. In particular embodiments, processor 602 may include one or more internal registers for data, instructions, or addresses. The present disclosure contemplates processor 602 including any suitable number of any suitable internal registers, where appropriate. Where appropriate, processor 602 may include one or more arithmetic logic units (ALUs); be a multi-core processor; or include one or more processors 602. Although this disclosure describes and illustrates a particular processor, this disclosure contemplates any suitable processor.

In particular embodiments, memory 604 includes main memory for storing instructions for processor 602 to execute or data for processor 602 to operate on. As an example and not by way of limitation, computer system 600 may load instructions from storage 606 or another source (such as, for example, another computer system 600) to memory 604. Processor 602 may then load the instructions from memory 604 to an internal register or internal cache. To execute the instructions, processor 602 may retrieve the instructions from the internal register or internal cache and decode them. During or after execution of the instructions, processor 602 may write one or more results (which may be intermediate or final results) to the internal register or internal cache. Processor 602 may then write one or more of those results to memory 604. In particular embodiments, processor 602 executes only instructions in one or more internal registers or internal caches or in memory 604 (as opposed to storage 606 or elsewhere) and operates only on data in one or more internal registers or internal caches or in memory 604 (as opposed to storage 606 or elsewhere). One or more memory buses (which may each include an address bus and a data bus) may couple processor 602 to memory 604. Bus 612 may include one or more memory buses, as described below. In particular embodiments, one or more memory management units (MMUs) reside between processor 602 and memory 604 and facilitate accesses to memory 604 requested by processor 602. In particular embodiments, memory 604 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. The present disclosure contemplates any suitable RAM. Memory 604 may include one or more memories 602, where appropriate. Although this disclosure describes and illustrates particular memory, this disclosure contemplates any suitable memory.

In particular embodiments, storage 606 includes mass storage for data or instructions. As an example and not by way of limitation, storage 606 may include an HDD, a floppy disk drive, flash memory, an optical disc, a magneto-optical disc, magnetic tape, or a Universal Serial Bus (USB) drive or a combination of two or more of these. Storage 606 may include removable or non-removable (or fixed) media, where appropriate. Storage 606 may be internal or external to computer system 600, where appropriate. In particular embodiments, storage 606 is non-volatile, solid-state memory. In particular embodiments, storage 606 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 606 taking any suitable physical form. Storage 606 may include one or more storage control units facilitating communication between processor 602 and storage 606, where appropriate. Where appropriate, storage 606 may include one or more storages 606. Although this disclosure describes and illustrates particular storage, this disclosure contemplates any suitable storage.

In particular embodiments, I/O interface 608 includes hardware, software, or both providing one or more interfaces for communication between computer system 600 and one or more I/O devices. Computer system 600 may include one or more of these I/O devices, where appropriate. One or more of these I/O devices may enable communication between a person and computer system 600. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 608 for them. Where appropriate, I/O interface 608 may include one or more device or software drivers enabling processor 602 to drive one or more of these I/O devices. I/O interface 608 may include one or more I/O interfaces 608, where appropriate. Although this disclosure describes and illustrates a particular I/O interface, this disclosure contemplates any suitable I/O interface.

In particular embodiments, communication interface 610 includes hardware, software, or both providing one or more interfaces for communication (such as, for example, packet-based communication) between computer system 600 and one or more other computer systems 600 or one or more networks. As an example and not by way of limitation, communication interface 610 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 610 for it. As an example and not by way of limitation, computer system 600 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 600 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 600 may include any suitable communication interface 610 for any of these networks, where appropriate. Communication interface 610 may include one or more communication interfaces 610, where appropriate. Although this disclosure describes and illustrates a particular communication interface, this disclosure contemplates any suitable communication interface.

In particular embodiments, bus 612 includes hardware, software, or both coupling components of computer system 600 to each other. As an example and not by way of limitation, bus 612 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCI-X) bus, a serial advanced technology attachment (SATA) bus, a Video Electronics Standards Association local (VLB) bus, or another suitable bus or a combination of two or more of these. Bus 612 may include one or more buses 612, where appropriate. Although this disclosure describes and illustrates a particular bus, this disclosure contemplates any suitable bus or interconnect.

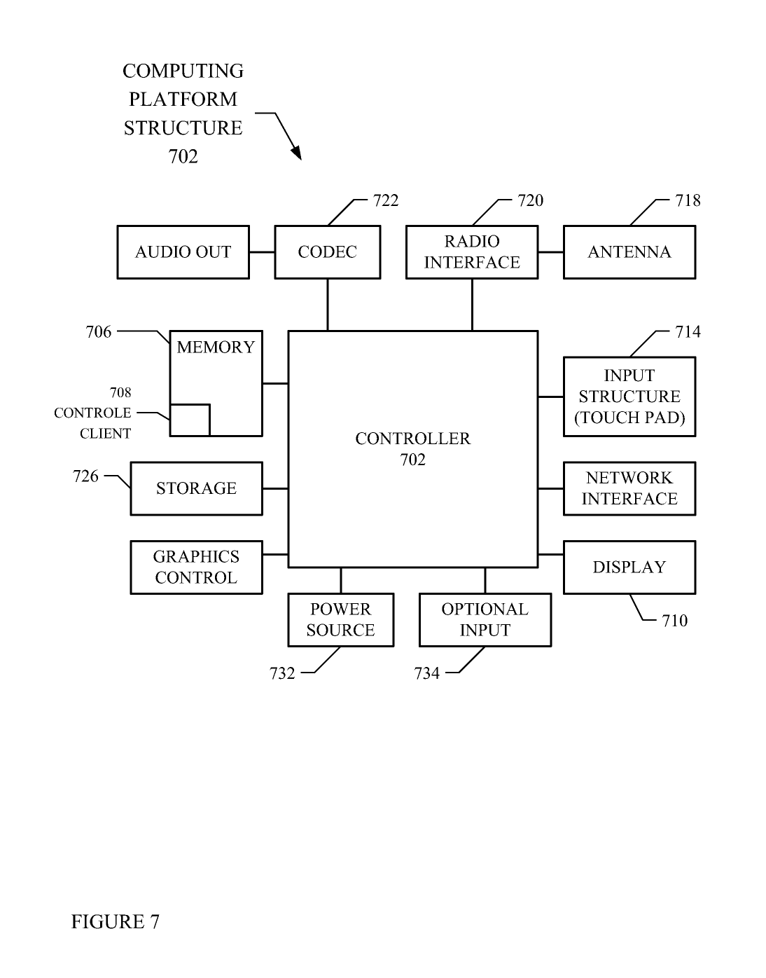

The client-side functionality described above can be implemented as a series of instructions stored on a computer-readable storage medium that, when executed, cause a programmable processor to implement the operations described above. While the client device 122 may be implemented in a variety of different hardware and computing systems, FIG. 7 shows a schematic representation of the main components of an example computing platform 702, according to various particular embodiments. Multipoint sensing devices generally include a controller 704 which may comprise a microcontroller or one or more processors configured to execute instructions and to carry out operations associated with a computing platform. In various embodiments, controller 704 may be implemented as a single-chip, multiple chips and/or other electrical components including one or more integrated circuits and printed circuit boards. Controller 704 may optionally contain a cache memory unit for temporary local storage of instructions, data, or computer addresses. By way of example, using instructions retrieved from memory, controller 704 may control the reception and manipulation of input and output data between components of computing platform 702.

Controller 704 together with a suitable operating system may operate to execute instructions in the form of computer code and produce and use data. By way of example and not by way of limitation, the operating system may be Windows-based, Mac-based, or Unix or Linux-based, or Symbian-based, among other suitable operating systems. The operating system, other computer code (including control client 708 described below) and/or data may be physically stored within a memory block 706 that is operatively coupled to controller 704.

Memory block 706 encompasses one or more storage media and generally provides a place to store computer code (e.g., software and/or firmware) and data that are used by the computing platform 702. By way of example, memory block 706 may include various tangible computer-readable storage media including Read-Only Memory (ROM) and/or Random-Access Memory (RAM). As is well known in the art, ROM acts to transfer data and instructions uni-directionally to controller 704, and RAM is used typically to transfer data and instructions in a bi-directional manner. Memory block 706 may also include one or more fixed storage devices in the form of, by way of example, solid-state hard disk drives (HDDs), among other suitable forms of memory coupled bi-directionally to controller 704. Information may also reside on a removable storage medium loaded into or installed in multipoint sensing devices when needed. By way of example, any of a number of suitable memory cards may be loaded into computing platform 702 on a temporary or permanent basis.

Controller 704 is also generally coupled to a variety of interfaces such as graphics control, video interface, input interface, output interface, and storage interface, and network interface, and these interfaces in turn are coupled to the appropriate devices. In certain embodiment, Controller 704 may connected to an input structure 714 and display 716 may be provided together, such an in the case of a touchscreen where a touch sensitive mechanism is provided in conjunction with the display 716. In such embodiments, the user may select or interact with displayed interface elements via the touch sensitive mechanism. In this way, the displayed interface may provide interactive functionality, allowing a user to navigate the displayed interface by touching the display 716.

Electric signals (e.g., analog) may be produced by microphone 710 and fed to earpiece 712. Controller 704 may receive instruction signals from input structure 714 and control the operation of display 716. By way of example, display 716 may incorporate liquid crystal display (LCD), light emitting diode (LED), Interferometric modulator display (IMOD), or any other suitable display technology. Audio signals may be transmitted and received by means of an antenna 718 that may be connected through a radio interface 720 or audio input interface such as microphone 724 to codec 722 configured to process signals under control of controller 704. Additionally, multipoint sensing devices may be powered power source 732.

Mobile device may also include one or more user input devices 734 (other than input structure 714) that are operatively coupled to the controller 704. Generally, input devices 734 are configured to transfer data, commands and responses from the outside world into multipoint sensing devices. By way of example, mobile device may include a keyboard or mouse. Input devices 734 may also include one or more hard buttons.

Display device 716 is generally configured to display a graphical user interface (GUI) that provides an easy to use visual interface between a user of the computing platform 702 and the operating system or application(s) running on the mobile device. Generally, the GUI presents programs, files and operational options with graphical images. During operation, the user may select and activate various graphical images displayed on the display 716 in order to initiate functions and tasks associated therewith.

Herein, reference to a computer-readable storage medium encompasses one or more non-transitory, tangible computer-readable storage media possessing structure. As an example and not by way of limitation, a computer-readable storage medium may include a semiconductor-based or other integrated circuit (IC) (such, as for example, a field-programmable gate array (FPGA) or an application-specific IC (ASIC)), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. Herein, reference to a computer-readable storage medium excludes any medium that is not eligible for patent protection under 35 U.S.C. §101. Herein, reference to a computer-readable storage medium excludes transitory forms of signal transmission (such as a propagating electrical or electromagnetic signal per se) to the extent that they are not eligible for patent protection under 35 U.S.C. §101.

This disclosure contemplates one or more computer-readable storage media implementing any suitable storage. In particular embodiments, a computer-readable storage medium implements one or more portions of processor 602 (such as, for example, one or more internal registers or caches), one or more portions of memory 604, one or more portions of storage 606, or a combination of these, where appropriate. In particular embodiments, a computer-readable storage medium implements RAM or ROM. In particular embodiments, a computer-readable storage medium implements volatile or persistent memory. In particular embodiments, one or more computer-readable storage media embody software. Herein, reference to software may encompass one or more applications, bytecode, one or more computer programs, one or more executables, one or more instructions, logic, machine code, one or more scripts, or source code, and vice versa, where appropriate. In particular embodiments, software includes one or more application programming interfaces (APIs). This disclosure contemplates any suitable software written or otherwise expressed in any suitable programming language or combination of programming languages. In particular embodiments, software is expressed as source code or object code. In particular embodiments, software is expressed in a higher-level programming language, such as, for example, C, Perl, or a suitable extension thereof. In particular embodiments, software is expressed in a lower-level programming language, such as assembly language (or machine code). In particular embodiments, software is expressed in JAVA. In particular embodiments, software is expressed in Hyper Text Markup Language (HTML), Extensible Markup Language (XML), or other suitable markup language.

The present disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend.

What is claimed is:

1. A method, comprising
generating, at a geo-social networking system, and sending an offer to a first user based on the first user's location, wherein the offer includes a check-in requirement and a user tagging requirement;
receiving from the first user a message indicating completion of the user tagging requirement;
generating, responsive to the message, a redeemable certificate; and
transmitting the redeemable certificate to the first user.

2. The method of claim 1 wherein the message further indicates completion of the check-in requirement.

3. The method of claim 1 wherein one or more tagged users of the user tagging requirement are first-degree connections of the first user.

4. The method of claim 1 wherein generating the redeemable certificate comprises
accessing a data store for pictures corresponding to the first user and one or more tagged users; and wherein the redeemable certificate includes the pictures corresponding to the first user and the one or more tagged users.

5. The method of claim 4 wherein accessing a data store for pictures corresponding to the first user and one or more tagged users is further based on one or more privacy settings and wherein the redeemable certificate includes the pictures corresponding to the first user and the one or more tagged users as permitted by the one or more privacy settings.

6. The method of claim 1 further comprising posting, in response to the message, a check-in activity element to a news feed of a social networking system.

7. The method of claim 1 wherein the redeemable certificate further comprises a graphical code symbol.

8. The method of claim 1 further comprising receiving data indicating a location of a user;
accessing one or more data stores of places and advertisements;
generating a list of places based on the location of the user;
ranking the list of places based at least in part on respective distances between the location and each place and whether an advertisement is associated with the place; and
presenting the ranked list of places to the user.

9. The method of claim 8 wherein the ranked list of places includes indicators for those places in the list of places having advertisements.

10. A system comprising:
a memory;
one or more processors; and
a non-transitory, storage medium storing computer-readable instructions operative, when executed, to cause the one or more processors to:
generate and send an offer to a first user based on the first user's location, wherein the offer includes a check-in requirement and a user tagging requirement;
receive from the first user a message indicating completion of the user tagging requirement;
generate, responsive to the message, a redeemable certificate; and
transmit the redeemable certificate to the first user.

11. The system of claim 10 wherein the message further indicating completion of the check-in requirement.

12. The system of claim 10 wherein one or more tagged users of the user tagging requirement are first-degree connections of the first user.

13. The system of claim 10, wherein to generate the redeemable certificate, comprising instructions operable to cause the one or more processors to:
access a data store for pictures corresponding to the first user and one or more tagged users; and wherein the redeemable certificate includes the pictures corresponding to the first user and the one or more tagged users.

14. The system of claim 13, wherein to access a data store for pictures corresponding to the first user and one or more tagged users is further based on one or more privacy settings and wherein the redeemable certificate includes the pictures corresponding to the first user and the one or more tagged users as permitted by the one or more privacy settings.

15. The system of claim 10 further comprising instructions operable to cause the one or more processors to post, in response to the message, a check-in activity element to a news feed of a social networking system.

16. The system of claim 10 wherein the redeemable certificate further comprises a graphical code symbol.

17. The system of claim 10, further comprising instructions operable to cause the one or more processors to:
receive data indicating a location of a user;
access one or more data stores of places and advertisements;
generate a list of places based on the location of the user;
rank the list of places based at least in part on respective distances between the location and each place and whether an advertisement is associated with the place; and
present the ranked list of places to the user.

18. The system of claim 17 wherein the ranked list of places includes indicators for those places in the list of places having advertisements.

19. One or more computer-readable tangible storage media embodying software operable when executed by one or more computing devices to:
generate and send an offer to a first user based on the first user's location, wherein the offer includes a check-in requirement and a user tagging requirement;
receive from the first user a message indicating completion of the user tagging requirement;
generate, responsive to the message, a redeemable certificate; and
transmit the redeemable certificate to the first user.

20. The media of claim 19 wherein the message further indicating completion of the check-in requirement.
